(19) United States
(12) Patent Application Publication
(10) Pub. No.: US 2026/0366597 A1
(43) Pub. Date: Nov. 19, 2026

(54) CHAIN

(71) Applicant: TSUBAKIMOTO CHAIN CO., Osaka (JP)

(72) Inventors: Daisuke Nakao, Osaka-shi (JP); Masahiro Koyama, Osaka-shi (JP)

(73) Assignee: TSUBAKIMOTO CHAIN CO., Osaka (JP)

(21) Appl. No.: 19/668,999

(22) Filed: May 6, 2026

(30) Foreign Application Priority Data
May 13, 2025 (JP) 2025-080558

(51) Int. Cl. F16G 13/06

(52) U.S. Cl. CPC F16G 13/06

(57) ABSTRACT

To provide a chain having a simple structure and improved frictional properties without increasing contact pressure, thereby minimizing wear of a sliding counterpart even under insufficient lubrication conditions. The chain includes: inner link plates each having a pair of coupling holes through each of which a pin or bushing is insertable; and outer link plates each having a pair of pin holes through each of which a pin is insertable. The inner link plates and/or the outer link plates are provided with a high-slidability portion having high sliding properties on a surface thereof.

### BACKGROUND OF THE INVENTION

### 1. Field of the Invention

The present invention relates to a chain composed of inner link plates each having a pair of coupling holes through each of which a pin or bushing is insertable, and outer link plates each having a pair of pin holes through each of which a pin is insertable.

### 2. Description of the Related Art

Some known chains are conventionally composed of inner link plates each having a pair of coupling holes through each of which a pin or bushing is insertable, and outer link plates each having a pair of pin holes through each of which a pin is insertable as described, for example, in Japanese Patent Application Publication No. 2012-255523.

The chain (power transmission chain 100) described in Japanese Patent Application Publication No. 2012-255523 includes inner link plates (110) each having a pair of coupling holes (bushing holes 111) through which a pin (coupling pin 150) or bushing (120) is insertable, and outer link plates (140) each having a pair of pin holes (141) through which a pin (coupling pin 150) is insertable. The inner link plates (110) have an oblong outer shape including circular arc contact regions (112) where the inner link plates make sliding contact with a guide shoe (chain guide G).

The inner link plates (110) make sliding contact with the guide shoe (chain guide G) at their circular arc contact regions (112) before the end faces (linear regions) of the outer link plates (140) come into sliding contact with the guide shoe (chain guide G), thereby preventing the sliding end faces (linear regions) of the outer link plates (140) from contacting the guide shoe (chain guide G). Therefore, irrespective of whether the front surface or the rear surface of the plates is oriented outward in the chain width direction when being assembled, the overall contact area between the chain (power transmission chain 100) and the guide shoe (chain guide G) is reduced, which contributes to a reduction in friction resistance. Moreover, the clearance between the outer link plates (140) and the guide shoe (chain guide G) allows lubricating oil to flow more easily therebetween, thereby reducing friction loss during power transmission and improving transmission efficiency.

### SUMMARY OF THE INVENTION

The known chain described in the above cited patent documents still leaves room for improvement.

Namely, the chain described in Japanese Patent Application Publication No. 2012-255523 and other patent documents is configured such that only the inner link plates make sliding contact with the chain guide. The reduced contact area between the chain and the chain guide increases contact pressure, which may compromise the effect of minimizing wear of the chain guide, especially under conditions where lubricating oil is insufficiently supplied to the circular arc contact regions, such as at engine start.

Under insufficient lubrication conditions, the lubricating oil may not be sufficiently supplied to the circular arc contact regions even during sliding movement of the chain, hence wear of the chain and the chain guide cannot be sufficiently prevented.

To address these issues, an object of the present invention is to provide a chain having a simple structure and improved frictional properties without increasing contact pressure, thereby minimizing wear of a sliding counterpart even under insufficient lubrication conditions.

The chain according to the present invention includes: inner link plates each having a pair of coupling holes through each of which a pin or bushing is insertable; and outer link plates each having a pair of pin holes through each of which a pin is insertable, wherein a high-slidability portion having high sliding properties is formed on at least one of a surface of the inner link plates and a surface of the outer link plates, thereby achieving the above object.

In the chain according to the invention set forth in claim 1, a high-slidability portion having high sliding properties is formed on a surface of the inner link plates and/or a surface of the outer link plates. When the chain slides in contact with a sliding counterpart, the high-slidability portions cause minimal wear of the sliding counterpart, enabling the sliding counterpart to be replaced less frequently.

Even when the contact pressure is increased by reducing the contact area between the sliding counterpart and the high-slidability portions of the chain to improve friction performance, wear of the sliding counterpart is minimized.

According to the configuration set forth in claim 2, the high-slidability portion on the surface of the inner link plates and/or the surface of the outer link plates is provided only on a sliding end face that makes contact with a sliding counterpart. The production cost can be reduced compared to when providing the high-slidability portion on the entire surface of the inner link plate and/or the entire surface of the outer link plate.

As the surfaces other than the sliding end face do not need to be processed, the link plates can be the same size as existing ones and handled in the same way when assembled into the chain.

According to the configuration set forth in claim 3, the high-slidability portion is provided only on one of the surface of the inner link plates and the surface of the outer link plates. For example, when the inner link plates and the outer link plates are different in size, the high-slidability portion may be provided only on the surface of the link plates that come into closer contact with the sliding counterpart. Production costs can thereby be reduced as compared with a configuration in which the high-slidability portion is provided on all of the link plates.

According to the configuration set forth in claim 4, the high-slidability portion is provided partially only on a surface of one of either the inner link plates or the outer link plates, with the one of either the inner link plates or the outer link plates being configured to have a sliding end face that makes contact with a sliding counterpart. In the case where there is a difference in wear resistance of sliding end faces due to the presence or absence of the high-slidability portions, the chain can be configured such that the outer link plates have the sliding end faces that are more susceptible to wear. The worn link plates can then be replaced without removing the inner link plates, so that maintenance efficiency can be improved.

Moreover, this configuration can prevent the inner link plates and outer link plates having the high-slidability portion on their sliding end faces from being inadvertently mixed with the inner link plates and outer link plates that do not have the high-slidability portion, thereby preventing inventory management from becoming complicated.

According to the configuration set forth in claim 5, the high-slidability portion is formed as a thin film. Since the presence or absence of the high-slidability portions hardly affects the shapes or dimensions of the link plates, the link plates can be the same size as existing ones and handled in the same way when assemble into and used as the chain.

According to the configuration set forth in claim 6, the high-slidability portion has a thickness of 0.001 mm or more and 0.020 mm or less. This thickness is sufficient to prevent wear of the high-slidability portion itself due to sliding contact with the sliding counterpart, while allowing the high-slidability portion to be formed as a thin film on the link plate surface without increasing the number of processing steps, thereby reducing production cost.

According to the configuration set forth in claim 7, the sliding end face has a surface roughness Ra of 0.5 or less. This can suppress excessive wear of the sliding counterpart even if the high-slidability portions are worn away during sliding contact.

### BRIEF DESCRIPTION OF THE DRAWINGS

FIG. 1 is a perspective view of a roller chain 100 according to one embodiment of the present invention;

FIG. 2 is a side view of the roller chain 100 according to one embodiment of the present invention;

FIG. 3 is a perspective view of an inner link plate 110 of the roller chain 100 according to one embodiment of the present invention;

FIG. 4 is a perspective view of an outer link plate 120 of the roller chain 100 according to one embodiment of the present invention;

FIG. 5 is a side view of the roller chain 100 according to one embodiment of the present invention, illustrating a sliding condition with a guide shoe G;

FIG. 6 is an A-A’ sectional view of the roller chain 100 according to one embodiment of the present invention, illustrating a sliding condition with a guide shoe G;

FIG. 7 is a perspective view of a roller chain 200 according to another embodiment of the present invention;

FIG. 8 is a side view of the roller chain 200 according to the embodiment of the present invention;

FIG. 9 is a perspective view of an inner link plate 210 of the roller chain 200 according to the embodiment of the present invention;

FIG. 10 is a side view of the roller chain 200 according to the embodiment of the present invention, illustrating a sliding condition with a guide shoe G; and

FIG. 11 is an B-B’ sectional view of the roller chain 200 according to the embodiment of the present invention, illustrating a sliding condition with a guide shoe G.

### DESCRIPTION OF THE PREFERRED EMBODIMENTS

Hereinafter, a roller chain 100 according to one embodiment of the present invention is described with reference to the drawings.

The roller chain 100, which is a chain according to one embodiment of the present invention, is used as a timing chain inside a car engine and passed over a drive sprocket (not shown) and a rockable sprocket (not shown). A tensioner (not shown) is used to press a pivotable lever guide (not shown) to apply a predetermined tension on the roller chain 100.

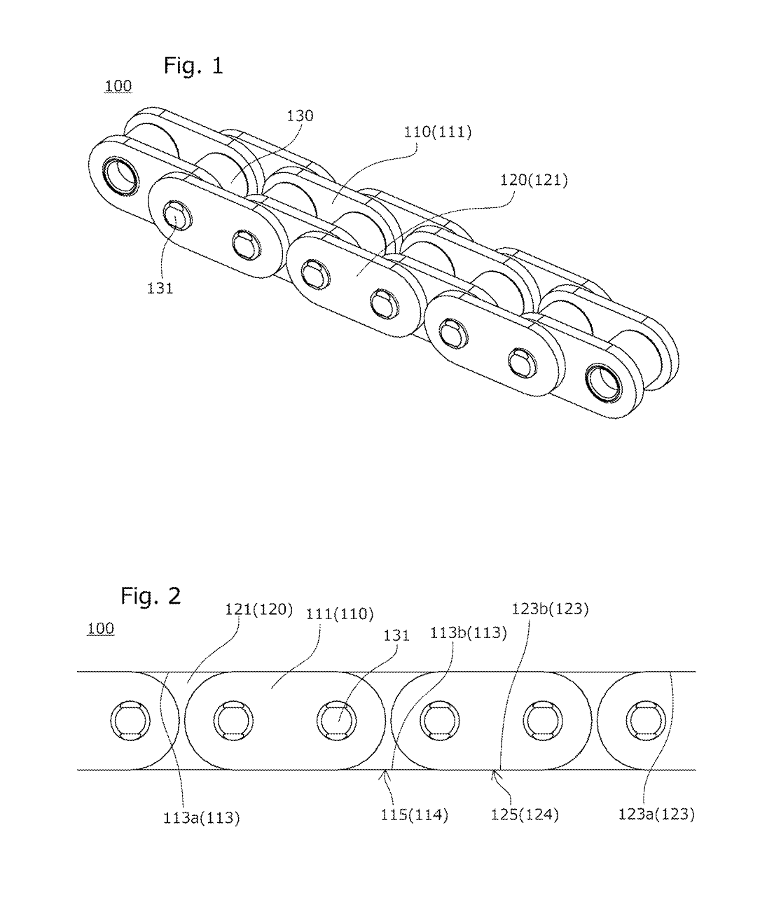

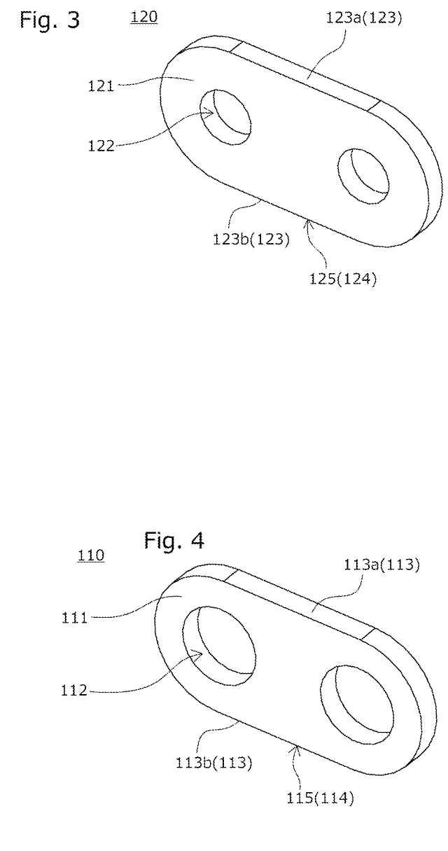

At engine start, the roller chain 100 under predetermined tension slides into contact with a contact surface Gs of a guide shoe G that is to be described later. As shown in FIGS. 1 - 4, the roller chain includes inner link plates 110 each having a pair of bushing holes 112 that are coupling holes through each of which a pin 131 and a bushing 132 are insertable, and outer link plates 120 each having a pair of pin holes 122 through each of which the pin is insertable. The inner link plates 110 and the outer link plates 120 are alternately coupled together in an endless loop.

The inner link plate 110 includes bushing holes 112 that extend through an inner main body 111, and inner side surfaces 113 that are the upper and lower end faces of the inner main body 111 (an upper inner side surface 113a and a lower inner side surface 113b).

The lower inner side surface 113b may also be called an inner sliding end face 114 that makes sliding contact with and slides against a contact surface Gs of the guide shoe G. The inner sliding end face 114 is provided with an inner high-slidability portion 115.

The outer link plate 120 includes pin holes 122 that extend through an outer main body 121, and outer side surfaces 123 that are the upper and lower end faces of the outer main body 121 (an upper outer side surface 123a and a lower outer side surface 123b).

The lower outer side surface 123b may also be called an outer sliding end face 124 that makes sliding contact with and slides against the contact surface Gs of the guide shoe G. The outer sliding end face 124 is provided with an outer high-slidability portion 125.

The inner high-slidability portions 115 and the outer high-slidability portions 125 of the roller chain 100 according to this embodiment are thin coating films formed on the surfaces of the inner sliding end faces 114 and the outer sliding end faces 124. The inner high-slidability portions 115 and the outer high-slidability portions 125 have higher slidability than the inner side surfaces 113 and the outer side surfaces 123 (the inner sliding end faces 114 and the outer sliding end faces 124).

The length between the inner side surfaces 113 of the inner link plate 110 is the same as the length between the outer side surfaces 123 of the outer link plate 120.

Namely, the inner link plates 110 and outer link plates 120 both make sliding contact and slide against the contact surface Gs on their inner sliding end faces 114 and outer sliding end faces 124.

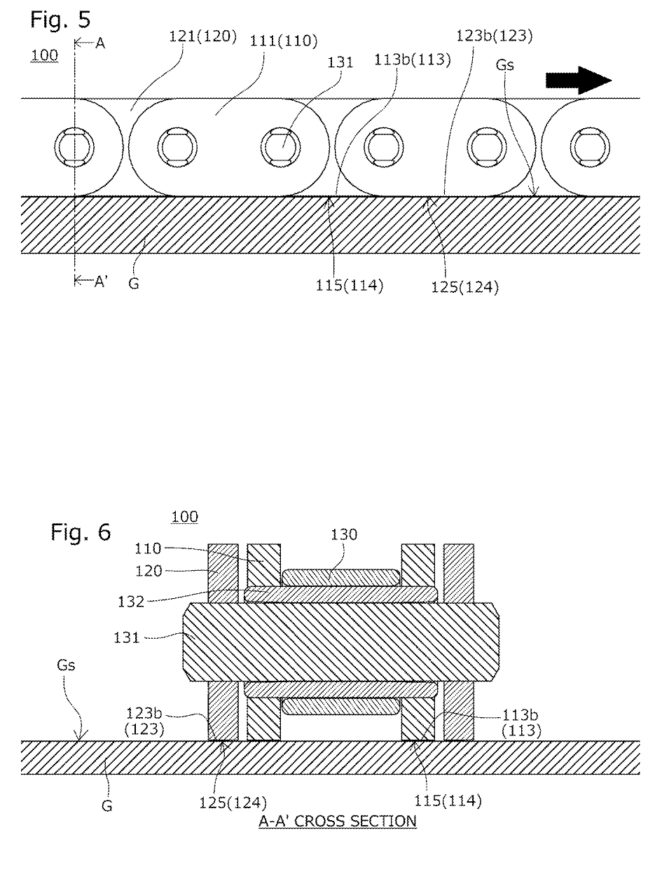

Next, the sliding condition between the roller chain 100 according to one embodiment of the present invention and the contact surface Gs of the guide shoe G is explained with reference to FIGS. 5 and 6.

Although not shown, the contact surface Gs is supplied with lubricating oil.

Before the engine starts, the roller chain 100 under predetermined tension is stationary, with the lower inner side surfaces 113b and the lower outer side surfaces 123b being in contact with the contact surface Gs. Therefore, the lubricating oil has not flown yet between the inner high-slidability portions 115 and the contact surface Gs, and between the outer high-slidability portions 125 and the contact surface Gs.

When the engine is started in this state, the roller chain 100 starts moving in the forward direction (rightward in FIG. 5, toward the viewer in FIG. 6) by the rotation of the drive sprocket, in sliding contact with the contact surface Gs.

Since the inner high-slidability portions 115 and the outer high-slidability portions 125 have high slidability, the sliding movement between the inner and outer high-slidability portions 115 and 125 and the contact surface Gs hardly causes wear on the contact surface Gs.

Moreover, the roller chain 100 can start sliding without causing wear on the contact surface Gs even before the lubricating oil has flown between the inner high-slidability portions 115 and the contact surface Gs, and between the outer high-slidability portions 125 and the contact surface Gs, or even under insufficient lubrication conditions.

Accordingly, the replacement frequency of the guide shoe G and the amount of lubricating oil to be used can be reduced. The frequency of maintenance of the engine itself, which may be required due to wear of the guide shoe G, is also reduced.

While the inner high-slidability portions 115 and the outer high-slidability portions 125 are respectively formed on the lower inner side surfaces 113b (inner sliding end faces 114) and the lower outer side surfaces 123b (outer sliding end faces 124), a high-slidability portion can be formed also on the upper inner side surfaces 113a and the upper outer side surfaces 123a so that the roller chain 100 can slide against a sliding counterpart on both upper and lower sides.

The high-slidability portion may be formed on an entire surface of the inner link plate 110 and/or an entire surface of the outer link plate 120.

The high-slidability portion need not necessarily be formed on all portions that make sliding contact with the contact surface Gs. For example, the inner high-slidability portion 115 may be formed only on the inner sliding end faces 114, while the outer high-slidability portion 125 may be omitted from the outer link plates 120. In such a roller chain configuration, the outer sliding end faces 124 of the outer link plates 120 are more prone to wear than the sliding end faces of the inner link plates 110. During maintenance when only worn link plates are replaced, this configuration allows the replacement without removing the inner link plates 110, so that maintenance efficiency can be improved.

Moreover, this configuration can prevent inner link plates and outer link plates having a high-slidability portion on their sliding end faces from being inadvertently mixed with inner link plates and outer link plates that do not have the high-slidability portion, thereby preventing inventory management from becoming complicated.

The number of high-slidability portions provided on the inner link plates 110 or the outer link plates 120 can be adjusted to achieve a desired balance between low-friction performance and wear reduction of the guide shoe G.

The inner high-slidability portions 115 and the outer high-slidability portions 125 of the roller chain 100 are formed as thin coating films, so that the presence or absence of the high-slidability portions hardly affects the shapes or dimensions of the link plates. Accordingly, the link plates can be the same size as existing ones and handled in the same way when assemble into and used as the chain.

Specifically, the high-slidability portion may be formed to have a thickness of 0.001 mm or more and 0.020 mm or less. This thickness is sufficient to prevent wear of the high-slidability portion itself due to sliding contact with the contact surface Gs, while allowing the high-slidability portion to be formed as a coating film on the link plate surface without increasing the number of processing steps, thereby reducing production cost.

Specifically, preferred examples of the coating film include, but are not limited to, a DLC coating, a TiC coating, and a MoS₂ coating.

Alternatively, rather than forming a coating film, the high-slidability portion may be formed by shot peening, by bonding a thin plate material having high slidability to the inner sliding end face 114 and/or the outer sliding end face 124, or by applying a combination of two or more different coatings.

After a prolonged period of sliding contact between the roller chain 100 and the guide shoe G, the high-slidability portions may become worn, thereby exposing the inner sliding end faces 114 and the outer sliding end faces 124. The inner sliding end faces 114 and the outer sliding end faces 124, if they have a surface roughness of 0.5 Ra or less, are capable of maintaining a relatively high degree of slidability even after such exposure. Accordingly, even when the exposed inner sliding end faces 114 and outer sliding end faces 124 slide against the contact surface Gs, excessive wear of the contact surface Gs can be prevented.

Next, a roller chain 200 according to another embodiment of the present invention is described with reference to the drawings.

Description of the same parts as those of the roller chain 100 according to the embodiment described above will be omitted.

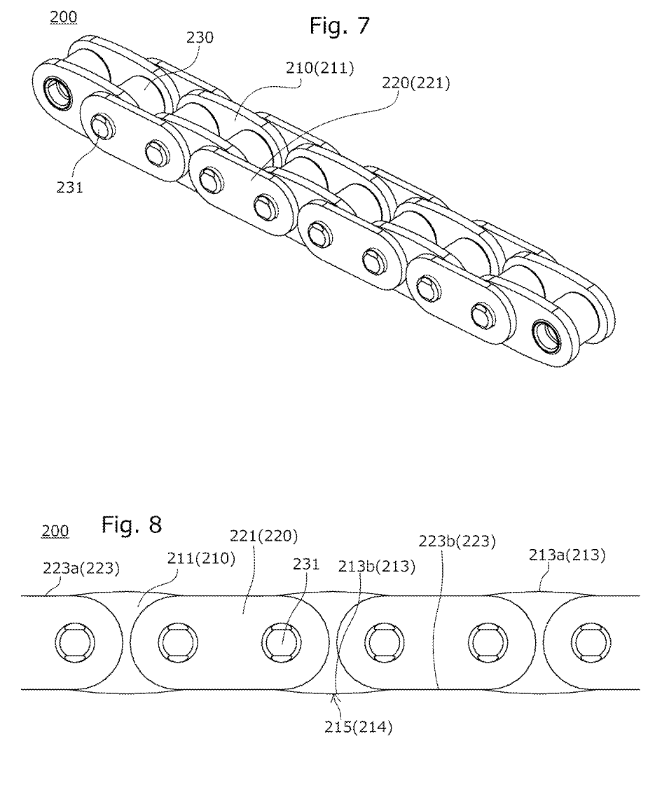

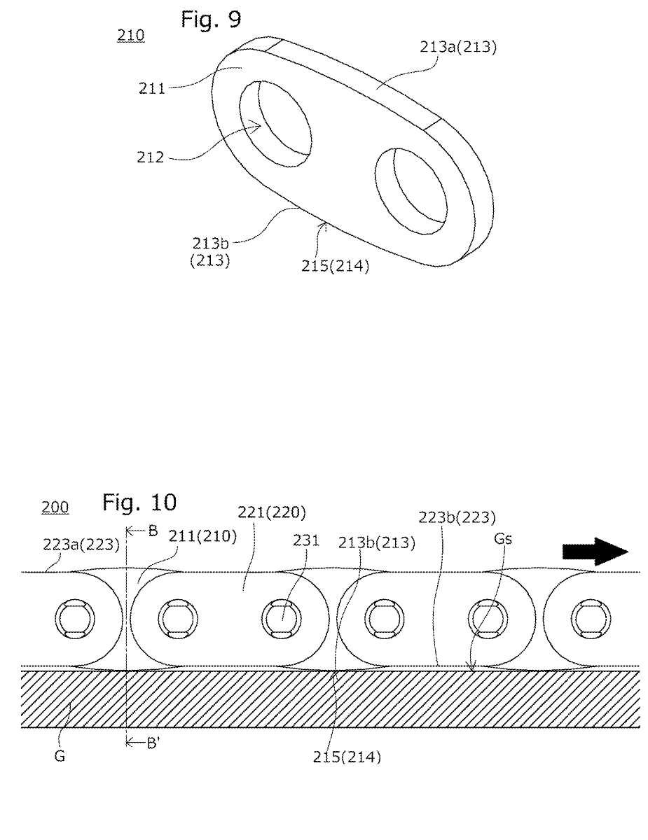

As shown in FIGS. 7 - 9, the inner link plate 210 of the roller chain 200 according to this embodiment has curved convex shape inner side surfaces 213 (an upper inner side surface 213a and a lower inner side surface 213b) so that the length between the inner side surfaces 213 is longer than the length between the outer side surfaces 223.

The inner sliding end face 214 is formed with an inner high-slidability portion 215.

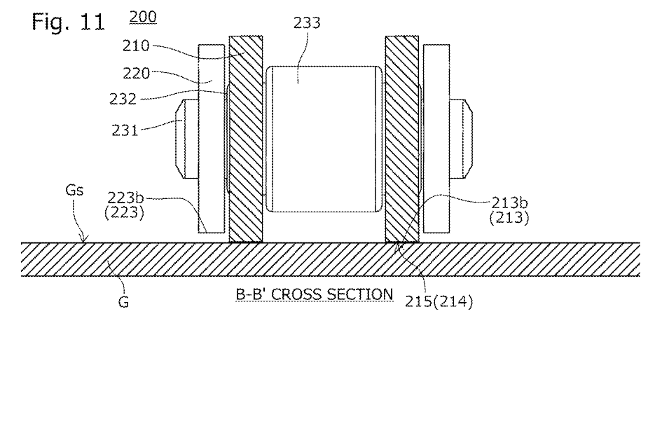

Next, the sliding condition between the roller chain 200 according to this embodiment of the present invention and the contact surface Gs of the guide shoe G is explained with reference to FIGS. 10 and 11.

Although not shown, the contact surface Gs is supplied with lubricating oil.

Since the length between the inner side surfaces 213 is longer than the length between the outer side surfaces 223, the lower inner side surfaces 213b of the inner link plates are in contact with the contact surface Gs, while the lower outer side surfaces 223b of the outer link plates are not in contact with the contact surface Gs, before the engine starts when the roller chain 200 is under predetermined tension.

Since the inner side surfaces 213 (the upper inner side surface 213a and the lower inner side surface 213b) have a curved convex shape, the contact area between the inner sliding end faces 214 and the contact surface Gs is smaller, so that friction performance is improved.

When the engine is started in this state, the roller chain 200 starts moving in the forward direction (rightward in FIG. 10, toward the viewer in FIG. 11) by the rotation of the drive sprocket, in sliding contact with the contact surface Gs.

Since the inner high-slidability portions 215 have high slidability, the sliding movement between the inner high-slidability portions 215 and the contact surface Gs hardly causes wear on the contact surface Gs.

The reduced contact area between the inner sliding end face 214 and the contact surface Gs increases the contact pressure, which may cause the contact surface Gs to be more susceptible to wear. However, the inner high-slidability portions 215 provided on the inner sliding end faces 213b can reduce wear of the contact surface Gs.

The curved convex shape of the inner side surfaces 213 allows lubricating oil to more easily flow toward the contact region between the inner high-slidability portions 215 and the contact surface Gs. Thus, immediately after engine start, lubricating oil is quickly supplied between the inner high-slidability portions 215 and the contact surface Gs, thereby suppressing wear of the guide shoe G at an early stage.

While one embodiment and another embodiment of the present invention have been described in detail, the present invention is not limited to these embodiments described above and may be carried out with various design changes without departing from the scope of the present invention set forth in the claims.

While the high-slidability portion is formed on the link plates of a roller chain in the embodiments described above, the application is not limited to roller chains. For example, the high-slidability portion may be formed on components of a silent chain.

While lubricating oil is supplied to the contact surface of the guide shoe in the embodiments described above, the lubricating oil may be omitted, for example.

What is claimed is:

1. A chain comprising: inner link plates each having a pair of coupling holes through each of which a pin or bushing is insertable; and outer link plates each having a pair of pin holes through each of which a pin is insertable, wherein
a high-slidability portion having high sliding properties is provided on at least one of a surface of the inner link plates and a surface of the outer link plates.

2. The chain according to claim 1, wherein the high-slidability portion on at least one of the surface of the inner link plates and the surface of the outer link plates is provided only on a sliding end face that makes contact with a sliding counterpart.

3. The chain according to claim 1, wherein the high-slidability portion is provided only on one of the surface of the inner link plates and the surface of the outer link plates.

4. The chain according to claim 1, wherein the high-slidability portion is provided partially only on a surface of one of either the inner link plates or the outer link plates, with the one of either the inner link plates or the outer link plates being configured to have a sliding end face that makes contact with a sliding counterpart.

5. The chain according to claim 1, wherein the high-slidability portion is formed as a thin film.

6. The chain according to claim 4, wherein the high-slidability portion has a thickness of 0.001 mm or more and 0.020 mm or less.

7. The chain according to claim 1, wherein the sliding end face has a surface roughness of 0.5 Ra or less.
